(19) United States
(12) Patent Application Publication
(10) Pub. No.: US 2025/0224288 A1
(43) Pub. Date: Jul. 10, 2025

(54) A SENSOR ZEROING APPARATUS AND METHOD FOR A HANDLEBAR

(71) Applicant: Logistics and Supply Chain MultiTech R&D Centre Limited, Pok Fu Lam (HK)

(72) Inventor: Wing Leung Chow, Pok Fu Lam (HK)

(21) Appl. No.: 18/406,772

(22) Filed: Jan. 8, 2024

(51) Int. Cl. G01L 1/26; B62B 5/00; B62B 5/04; G01L 5/22

(52) U.S. Cl. CPC G01L 1/26; B62B 5/0033; B62B 5/0073; B62B 5/0404; G01L 5/22

(57) ABSTRACT

A sensor zeroing apparatus for a handlebar including a drop bar moveably coupled to a handlebar of a wheeled transport device, wherein the drop bar is moveable relative to the handlebar between a pressed position and rest position, a drop bar position sensor located on or adjacent the handlebar, a controller is operatively coupled to the drop bar position sensor and one or more sensors, wherein the one or more sensors are positioned on the handlebar and/or a wheeled transport device comprising the handlebar, wherein the controller is configured to a sensor zeroing process if the drop bar is determined to be in the rest position.

### TECHNICAL FIELD

The present invention relates to a sensor zeroing apparatus and method for a handlebar, in particular an automated sensor zeroing apparatus and method for a force sensing handlebar of a wheeled transport device.

### BACKGROUND

Trolleys, carts wheelchairs are all devices that are used manually to move loads. For example, trolleys and carts are often manually driven and widely used in logistics to move loads.

Wheelchairs are used in many different situations to move people who are immobile or have limited mobility. All these wheeled transport devices can suffer from drawbacks that heavier loads place greater physical demands on the user to move these loads. Additionally for moving larger loads, in addition to the physical efforts, steering and manoeuvring can become challenging. To address this motorised or power assisted trolleys, carts or wheelchairs.

These powered wheeled transport devices are driven by a power source such as an electric motor and having associated controls for the drive source. Power assisted trolleys or carts or wheelchairs often include sensors such as strain gauges, power meters, torque sensors embedded into a control mechanism. These sensors are generally embedded into the handlebar to capture input forces from a user. Theses sensors are very sensitive and are susceptible to sensor drift. Sensor drift is where the output values drift over time or due to temperature changes. This leads to sensor error and can adversely affect the operation of powered wheeled transport devices.

### SUMMARY OF THE INVENTION

In accordance with one aspect, there is provided a sensor zeroing apparatus for a handlebar comprising:
a drop bar moveably coupled to a handlebar of a wheeled transport device, wherein the drop bar is moveable relative to the handlebar between a pressed position and rest position,
a drop bar position sensor located on or adjacent the handlebar,
a controller is operatively coupled to the drop bar position sensor and one or more sensors, wherein the one or more sensors are positioned on the handlebar and/or a wheeled transport device comprising the handlebar,
wherein the controller is configured to a sensor zeroing process if the drop bar is determined to be in the rest position.

In one example wherein during a sensor zeroing process the controller is configured to:
determine if a drop bar is in a pressed position or in a rest position,
measure sensor values from one or more sensors, if the drop bar is detected as being in a rest position, and;
update a zero value for each of the one or more sensors while the drop bar is in the rest position.

In one example while the drop bar is in a rest position, the controller is configured to continuously:
determine if a new sensor value is measured from any one of the one or more sensors,
update the zero value for each of the one or more sensors if a new sensor value is measured,
store the updated zero value after each instance the zero value is updated.

In one example the controller is configured to: update the zero value for each sensor if a new sensor value is measured while the drop bar is detected in a rest position.

In one example the controller is configured to:
determine a position of the drop bar based on processing signals from the drop bar position sensor, and;
continuously determine if the drop bar is in a pressed position or a rest position.

In one example the controller is configured to:
actuate a component of a wheeled transport device comprising the drop bar if the drop bar is detected as being in a pressed position, or
measure sensor values and update a zero value and store the updated zero value, if the drop bar is detected as being in a rest position.

In one example the controller configured to:
receive signals indicative of a drop bar position from a drop bar position sensor,
determine the position of the drop bar relative to the handlebar,
determine the drop bar is in a pressed position if the distance of the drop bar relative to the handlebar is less than a threshold, and determine the drop bar is in a rest position if the distance between the drop bar and handlebar is greater than the threshold.

In one example the controller is configured to determine the drop bar is in a pressed position based on the drop bar position sensor detecting the drop bar is in contact with the handlebar and the controller further configured to determine the drop bar is in a rest position based on the drop bar position sensor detecting the drop bar is spaced from the handlebar.

In one example wherein the drop bar position sensor is a proximity sensor or a limit switch. Alternatively, the drop bar position sensor may be an inductive or capacitive sensor.

In one example the controller is configured to interrupt the sensor zeroing process if the drop bar is detected in the pressed position, and the controller is configured to actuate the wheeled transport device.

In one example the controller is configured to actuate the wheeled transport device when the drop bar is determined to be in a pressed position by actuating a motor, or activating a motor drive loop, or releasing a brake or by releasing a brake and actuating a motor.

In one example the one or more sensors are force sensors located on the handlebar and configured to detect forces exerted by a user of the wheeled transport device.

In one example the controller is configured to execute the sensor zeroing process automatically and continuously, while the drop bar is detected as being in the rest position.

In one example wherein the handlebar and sensor zeroing apparatus are positioned on a wheeled transport device, and wherein the drop bar is pivotably coupled to the handlebar.

In accordance with a further aspect, there is provided a wheeled transport device comprising: a handlebar and a sensor zeroing apparatus as per any one or more of the statements above. The wheeled transport device may be a trolley or wheelchair.

In accordance with a further aspect, there is provided a sensor zeroing method comprising the steps of:
determining if a drop bar is in a pressed position or in a rest position,
measuring sensor values from one or more sensors, if the drop bar is detected as being in a rest position, and;
updating a zero value for each of the one or more sensors while the drop bar is in the rest position.

In one example the sensor zeroing comprising the steps of:
determining if a new sensor value is measured from any one of the one or more sensors,
updating the zero value for each of the one or more sensors if a new sensor value is measured,
storing the updated zero value after each instance the zero value is updated.

In one example the sensor zeroing comprising the steps of:
continuously determining if the drop bar is in a pressed position or a rest position,
continuously executing the steps in claims 16 and 17 when the drop bar is in a rest position.

In one example the sensor zeroing method comprising the steps of:
receiving signals indicative of a drop bar position from a drop bar position sensor,
determining the position of the drop bar relative to the handlebar,
determining the drop bar is in a pressed position if the distance of the drop bar relative to the handlebar is less than a threshold,
determining the drop bar is in a rest position if the distance between the drop bar and handlebar is greater than the threshold, and
actuating a component of a wheeled transport device comprising the drop bar if the drop bar is detected as being in a pressed position or measuring sensor values and update a zero value and store the updated zero value, if the drop bar is detected as being in a rest position.

In one example the method comprising the steps of:
interrupting the sensor zeroing process if the drop bar is detected in the pressed position and
actuating the wheeled transport device, wherein actuating the wheeled transport device comprises actuating a motor, or activating a motor drive loop, or releasing a brake or by releasing a brake and actuating a motor.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art any country.

### BRIEF DESCRIPTION OF THE DRAWINGS

One or more example embodiments of the sensor zeroing apparatus or sensor zeroing method will now be described, by way of example, with reference to the accompanying drawings in which:

FIG. 1 illustrates an example of a trolley that comprises a sensor zeroing apparatus.

FIG. 2 illustrates an example sensor zeroing apparatus with the drop bar in a rest position.

FIG. 3 illustrates the sensor zeroing apparatus of FIG. 2, with the drop bar in a pressed position.

FIG. 4 illustrates a schematic diagram of a control system of the trolley of FIG. 1.

FIG. 5 illustrates a schematic diagram of the controller of the control system.

FIG. 6 illustrates an example sensor zeroing method.

FIG. 7 illustrates a further example sensor zeroing method.

FIG. 8 illustrates a user grasping the handlebar and drop bar, and the direction of travel of the drop bar relative to the handlebar.

FIG. 9 illustrates the drop bar position sensor and the drop bar in the rest position.

FIG. 10 illustrates the drop bar position sensor and the drop bar in a pressed position.

### DETAILED DESCRIPTION OF THE PREFERRED EMBODIMENTS

The present invention is directed to a sensor zeroing apparatus and a sensor zeroing method for a handlebar of a wheeled transport device. The sensor zeroing apparatus and sensor zeroing method is particularly suited for a force sensing handlebar that is used in a motorised wheeled transport device.

In one example embodiment the sensor zeroing apparatus for a handlebar of wheeled transport device comprises: a drop bar moveably coupled to a handlebar of a wheeled transport, wherein the drop bar is moveable relative to the handlebar between a pressed position and rest position, a drop bar position sensor located on or adjacent the handlebar, a controller is operatively coupled to the drop bar position sensor and one or more sensors, wherein the one or more sensors are positioned on the handlebar and/or a wheeled transport comprising the handlebar, and wherein the controller is configured to a sensor zeroing process if the drop bar is determined to be in the rest position.

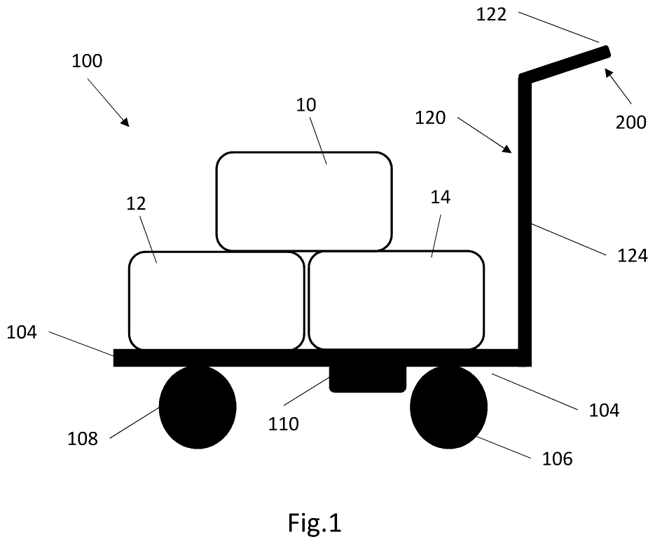

FIG. 1 illustrates an example of a wheeled transport device 100. In the illustrated example the wheeled transport device is a motorised trolley. The wheeled transport device 100 may be a motorised device or may be a manually driven device. Preferably the device 100 is a motorised device that assists a user to move loads. The wheeled transport device may be a trolley, or a cart or handcart used in logistics or may be a wheelchair or other motorised device that is used to move loads.

Referring to FIG. 1, the motorised trolley 100 that includes a chassis 102, a plurality of wheels mounted to the chassis 102 and a load platform 104 supported on the chassis 102. The motorised trolley 100 comprises four wheels, and one rear wheel 106 and one front wheel 108 is illustrated in FIG. 1. The trolley 100 comprises a motor 110 is mounted on the chassis 102 and is coupled to a pair of wheels. In one example, the motor 110 is coupled to the rear wheels 106 and adapted to drive the rear wheels. The rear wheels 106 act as the drive wheels to propel the motorised trolley 100. The wheels 106, 108 may be mounted with castors.

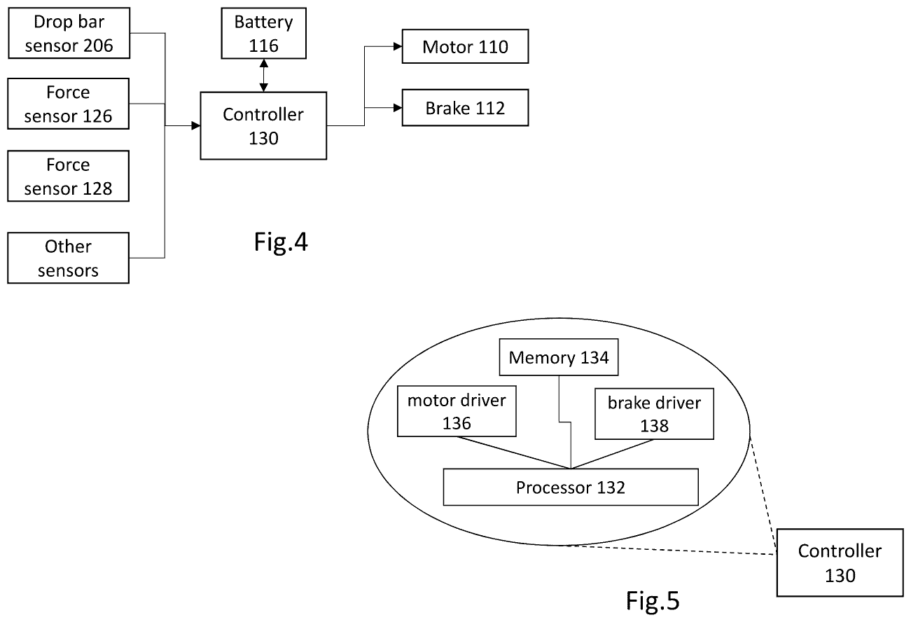

The trolley 100 further comprises a brake 112. The brake 112 may be associated with the drive wheels 106 and may be used to brake the trolley. The load platform 104 may be adapted to support a load 10, 12, 14. As shown in FIG. 4 boxes 10, 12, 14 are placed on the load platform 104. The load platform 104 may be a plate e.g., a metal plate or a wooden plate.

An upstanding handle mounting structure 120 may be fixed at its lower end to the chassis 102. The handle mounting structure 120 is fixed at a rear end of the chassis 102. A handlebar 122 is mounted to the handle mounting structure 120. The mounting structure 120 comprises a pair of stanchions 124 that may be connected to the chassis 102 and extend vertically from the chassis 102. The handlebar is an elongate member e.g., a rod that extends horizontally or transversely between the stanchions 124.

A plurality of sensors may be disposed on the trolley 100. One or more force sensors 126, 128 may be disposed on or connected to the handlebar 122. The force sensors 126, 128 may be configured to detect a force applied to the handlebar 122 by a user. For example, the force sensors can sense a pushing force or a pulling force or a turning force applied by the user as the user pushes the trolley 100. In one example, the trolley 100 comprises two force sensors 126, 128, and the force sensors 126, 128 are operatively coupled to a controller 130. The controller 130 may be mounted on the chassis 102.

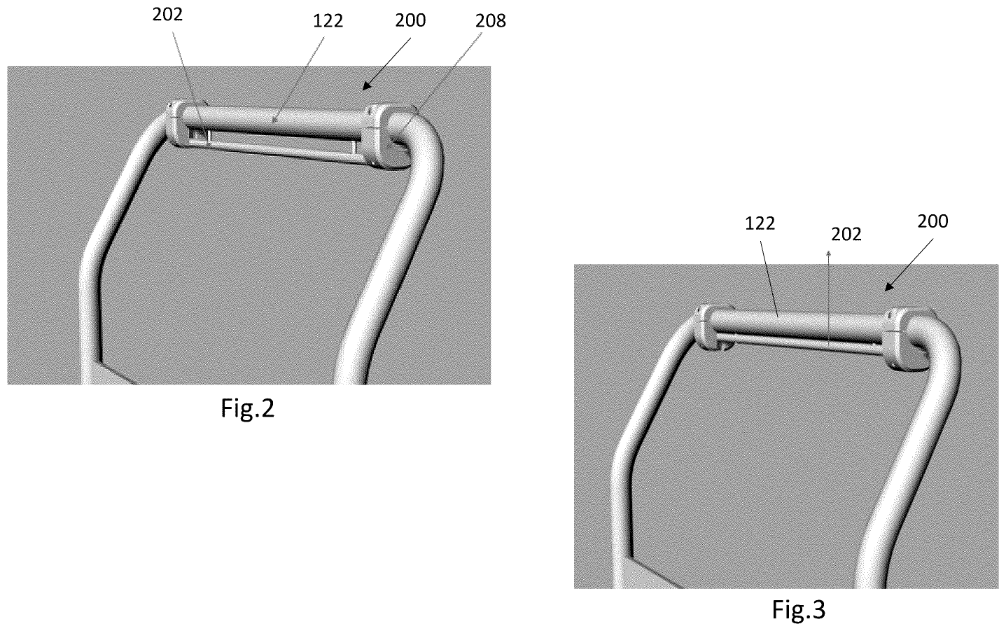

A sensor zeroing apparatus 200 for a handlebar is shown in FIG. 2 and FIG. 3. The sensor zeroing apparatus 200 may be mounted or connected on the handlebar 122. The sensor zeroing apparatus 200 comprises a drop bar 202. The drop bar 202 may be pivotably connected to the handlebar 122 or supported. In another example, the drop bar 202 may be cantilevered relative to the handlebar 122. The sensor zeroing apparatus may comprise a pair of supports that support the drop bar 202 relative to the handlebar 122. The drop bar 202 is held at two lateral ends by the supports. The supports are enclosed by a housing 208.

The drop bar 202 is moveable relative to the handlebar 122 between a pressed position and a rest position. The sensor zeroing apparatus 200 further comprises a drop bar position sensor 206 positioned adjacent the handlebar or on the handlebar or disposed within the handlebar 122. In the illustrated example in FIG. 9, the sensor 206 is mounted on the handlebar 122 and enclosed by the housing 208. The drop bar 202 is pressed by a user when the user grasps the handlebar 122 to use the trolley 100. The drop bar 202 moves toward the handlebar 122 when pressed i.e., moved into the pressed position or the drop bar 202 is released and can fall to a rest position due to gravity or a spring or resilient member in the support. FIG. 2 illustrates the drop bar 202 in a rest position and FIG. 3 illustrates the drop bar in a pressed position.

As shown in FIG. 8, a user grasps the handlebar 122 and the drop bar 202. FIG. 8 also illustrates the direction of travel of the drop bar relative to the handlebar 122. The drop bar 202 moves upward in the direction B when the user grasps the handlebar 122. When the user releases the handlebar 122, the drop bar 202 drops in the direction A.

The controller 130 may be part of the sensor zeroing apparatus 200. Referring to FIG. 4, the controller 130 may be operatively coupled to the drop bar position sensor 206, the force sensors 126, 128 and one or more other sensors on the trolley 100. For example, the other sensors may be weight sensors located on the platform 104. The controller 130 is further operatively coupled to a motor 110, the brake 112. The controller 130 is configured to activate the motor 110 and the brake 112. The controller 130 is operatively coupled to a battery 116. The battery 116 may be any suitable power source used to power the sensors and motor 110.

The controller 130 may comprise a processor 132 and memory unit 134, a motor driver 136 and a brake driver 138. The memory unit 134 may be a non-transitory computer readable medium e.g., a memory like ROM or RAM or Flash memory or a disk drive. The memory 134 may be used to store sensor values. The memory may further store calibration data of the sensors. The controller 130 is configured to provide signals to the motor driver 136. The motor driver 136 is electrically coupled to the motor 110 and is adapted to provide a driving signal to the motor 110. The brake driver 138 is adapted to provide a driving signal to the brake 112.

The controller 130 is operatively coupled to the drop bar position sensor 206. The controller 130 is configured to a sensor zeroing process if the drop bar is determined to be in the rest position. In one example the controller 130 is configured to determine if a drop bar is in a pressed position or in a rest position. The controller 130 is further configured to measure sensor values from one or more sensors if the drop bar is detected as being in a rest position. The controller 130 is configured to update a zero value for each of the one or more sensors while the drop bar is in the rest position.

The drop bar position sensor 206 may be a proximity sensor or a limit switch. Alternatively, the drop bar position sensor 206 may be an inductive sensor or capacitive sensor. The controller 130 is configured to receive signals indicative of a drop bar position from a drop bar position sensor. The controller 130 is further configured to determine the position of the drop bar relative to the handlebar. The controller 130 is configured to determine the drop bar is in a pressed position if the distance of the drop bar relative to the handlebar is less than a threshold and determine the drop bar is in a rest position if the distance between the drop bar and handlebar is greater than the threshold.

The controller 130 is configured to determine the drop bar is in a pressed position based on the drop bar position sensor detecting the drop bar is in contact with the handlebar and the controller further configured to determine the drop bar is in a rest position based on the drop bar position sensor detecting the drop bar is spaced from the handlebar. The controller 130 is configured to interrupt the sensor zeroing process if the drop bar is detected in the pressed position, and the controller is configured to actuate the wheeled transport device.

The controller 130 is configured to actuate the wheeled transport when the drop bar is determined to be in a pressed position by actuating a motor, or activating a motor drive loop, or releasing a brake or by releasing a brake and actuating a motor. In one example, when the drop bar 202 is moved into the pressed position, the motor may be actuated, and the current to the motor may be controlled based on the force exerted by a user on the handlebar. The exerted force may be detected by the force sensors 126, 128. The controller 130 may be configured to control the current to the motor in relation to the amount of force, thereby reducing the actual force required to move the trolley.

The controller 130 is configured to perform a sensor zeroing method 300. The sensor zeroing method 300 may be defined as computer readable instructions stored in the memory 134. The processor 132 may be configured to execute the stored instructions to cause the controller 134 to perform the sensor zeroing method 300. The controller is configured to execute the method 300.

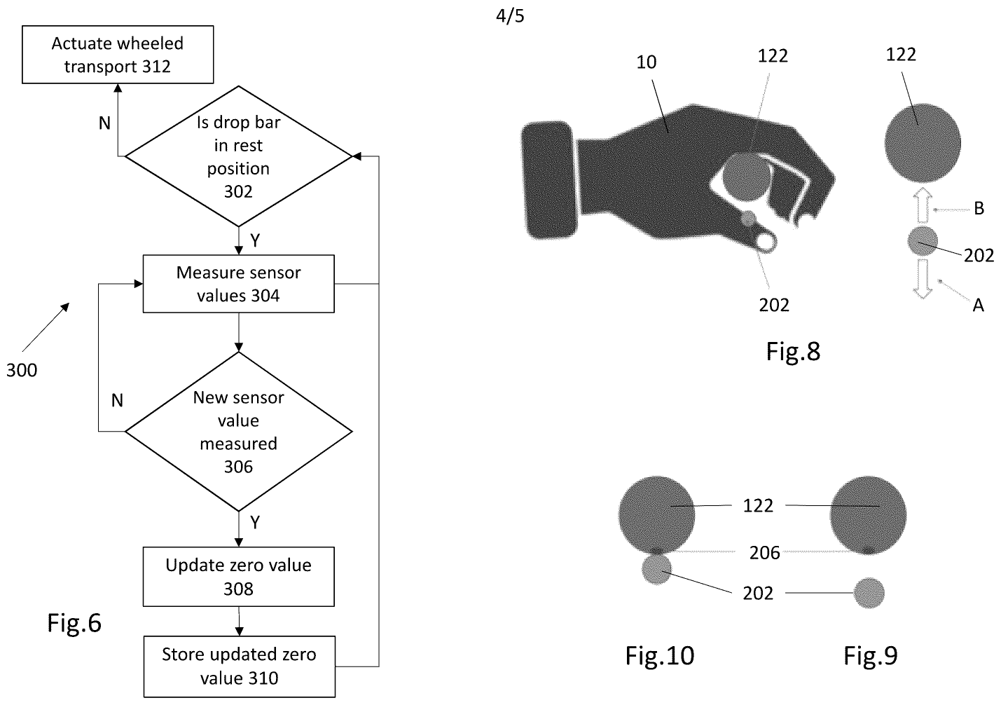

FIG. 6 illustrates a first example sensor zeroing method 300. At step 302 the controller is configured to determine if the drop bar is in a rest position. The controller may be configured to determine a position of the drop bar based on processing signals from the drop bar position sensor. The controller 300 may be configured to continuously determine if the drop bar is in a pressed position or a rest position. In one example, the drop bar 202 is detected as being in a pressed position if the drop bar position sensor 206 detects the drop bar is contacting the sensor 206 or if the distance between the drop bar and sensor 206 is less than a threshold.

If the drop bar 202 is detected as being in a pressed position e.g., as shown in FIG. 10 (the drop bar is in contact with the sensor 206), the wheeled transport is actuated at step 312. If the drop bar is detected in the rest position, the method moves to step 304.

Step 304 comprises measuring sensor values. At step 304, the controller 130 may be configured to measure values from the force sensors 126, 128. Optionally, at step 304 the controller 130 may also measure values from the drop bar position sensor and/or the other sensors. At step 306 the controller 130 determines if a new sensor value is detected. If no, the method returns to step 304. If yes, the method progresses to step 308.

Step 308 comprises updating the zero value of the sensors. At step 308 the controller 130 may be configured to recalibrate the sensors with a new zero value. The new zero value is the value measured at step 306. Step 310 comprises storing the updated zero values. The controller 130 may be configured to store the updated zero values i.e., the updated sensor calibration in the memory unit, at step 310. The updated zero values for the force sensors 126, 128 may be used in later operations. The updated zero values reduce sensor drift. The method 300 may be continuously repeated. The sensor zeroing process may be continuously repeated while the drop bar 202 is detected as being in a rest position.

The controller 130 may be configured to execute the sensor zeroing process 300 automatically and continuously, while the drop bar is detected as being in the rest position.

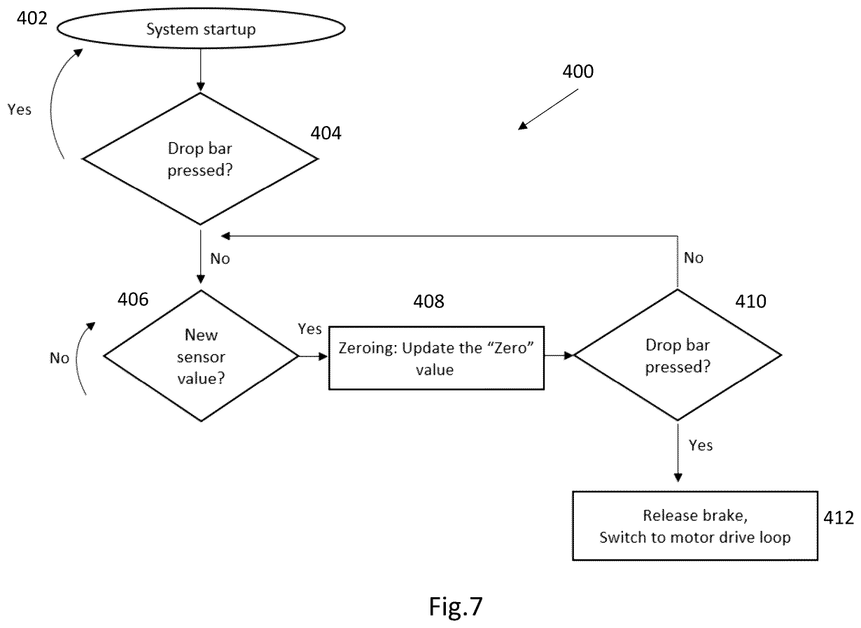

FIG. 7 illustrates a further example of a sensor zeroing method 400. At step 402 the system start up which denotes either the motorized trolley 100 is activated by a user who pressed the drop bar into a pressed position, as shown in FIG. 10 and may be moving the trolley.

Step 404 comprises determining if the drop bar 202 is in a pressed position. If yes, the method reverts to step 402. If not, the method executes step 406. At step 404, the controller 130 may be configured to determine the position of the drop bar 202 based on the signals from the drop bar position sensor 206. If the detected distance between the drop bar 202 and the sensor 206 or handlebar 122 is less than a threshold, the controller 130 determines the drop bar is in a pressed position. Otherwise, the drop bar 202 is determined to be in a rest position.

Step 406 comprises determining if a new sensor value is measured. The controller 130 is operatively coupled to the force sensors 126, 128. The controller 130 is configured to detect signals if the force sensors 126, 128 detect a new value while the drop bar 202 is a rest position. If new values are detected, the method progresses to step 408. New sensor values detected while the drop bar is in a rest position can be indicative of sensor drift. If no new values are measured step 406 may be repeated continuously.

Step 408 comprises zeroing the sensors. At step 408, the controller 130 is configured to update the zero value for each sensor. At step 408 the controller 130 may be configured to recalibrate each sensor by updating the zero value for each sensor where a new value is detected at step 406. The new zero value may be stored in a memory unit 134. The updated zero value corrects for sensor drift.

Step 410 follows step 408. At step 410 the controller 130 is configured to detect if the drop bar has been pressed. The drop bar 202 being pressed is detected by processing the signals from the drop bar position sensor 206. If the drop bar is detected as pressed the method moves to step 412. If at step 410 the drop bar is detected as being pressed, the zeroing process is interrupted.

At step 412 the brake 112 may be released and motor driver may be activated to drive the motor. The motor may be driven based on the force detected at the force sensors 126, 128. If at step 410, the drop bar is detected as being in the rest position i.e., the drop bar is not in the pressed position, the method proceeds to step 406. Steps 406 to 410 may be repeated while the drop bar is in the rest position.

The sensor zeroing method 300, 400 may be executed by the controller 130. The sensor zeroing method 300, 400 may be continuously repeated and executed while the drop bar is in the rest position, The sensor zeroing method 300, 400 may be an automated process, that is automatically executed while the drop bar 202 is in a rest position. The sensor zeroing apparatus continuously zeros the sensors i.e., continuously calibrates the sensors to re-zero sensors until the drop bar is pressed by a user.

The sensor zeroing apparatus 200 and sensor zeroing method 300, 400 is advantageous because the sensors are repeatedly zeroed. This zeroing of the sensors corrects for sensor drift over time of due to changes in temperature. The zeroing method is automatically executed and is advantageous because the user does not need to remember to recalibrate sensors correct for sensor drift. The automated nature of the sensor zeroing is advantageous because the sensors e.g., the sensitive force sensors are re-zeroed to correct for sensor drift. The sensor zeroing apparatus and sensor zeroing method is further advantageous because the continuous sensors being zeroed, while the drop bar is in a rest position, ensures the sensors are accurate. Zeroing a sensor is a technique to reset the sensors home value to prevent drifting.

It is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A sensor zeroing apparatus for a handlebar comprising:
a drop bar moveably coupled to a handlebar of a wheeled transport device, wherein the drop bar is moveable relative to the handlebar between a pressed position and rest position,
a drop bar position sensor located on or adjacent the handlebar,
a controller is operatively coupled to the drop bar position sensor and one or more sensors, wherein the one or more sensors are positioned on the handlebar and/or a wheeled transport device comprising the handlebar,
wherein the controller is configured to a sensor zeroing process if the drop bar is determined to be in the rest position.

2. A sensor zeroing apparatus of claim 1, wherein during a sensor zeroing process the controller is configured to:
determine if a drop bar is in a pressed position or in a rest position,
measure sensor values from one or more sensors, if the drop bar is detected as being in a rest position, and;
update a zero value for each of the one or more sensors while the drop bar is in the rest position.

3. The apparatus of claim 2, wherein while the drop bar is in a rest position, the controller is configured to continuously:
determine if a new sensor value is measured from any one of the one or more sensors,
update the zero value for each of the one or more sensors if a new sensor value is measured,
store the updated zero value after each instance the zero value is updated.

4. The apparatus of claim 3, wherein controller is configured to: update the zero value for each sensor if a new sensor value is measured while the drop bar is detected in a rest position.

5. The apparatus of claim 4, wherein the controller is configured to:
determine a position of the drop bar based on processing signals from the drop bar position sensor, and;
continuously determine if the drop bar is in a pressed position or a rest position.

6. The apparatus of claim 5, wherein the controller is configured to:
actuate a component of a wheeled transport device comprising the drop bar if the drop bar is detected as being in a pressed position, or
measure sensor values and update a zero value and store the updated zero value, if the drop bar is detected as being in a rest position.

7. The apparatus of claim 5, wherein the controller configured to:
receive signals indicative of a drop bar position from a drop bar position sensor,
determine the position of the drop bar relative to the handlebar,
determine the drop bar is in a pressed position if the distance of the drop bar relative to the handlebar is less than a threshold and determine the drop bar is in a rest position if the distance between the drop bar and handlebar is greater than the threshold.

8. The apparatus of claim 7, wherein the controller is configured to determine the drop bar is in a pressed position based on the drop bar position sensor detecting the drop bar is in contact with the handlebar and the controller further configured to determine the drop bar is in a rest position based on the drop bar position sensor detecting the drop bar is spaced from the handlebar.

9. The apparatus of claim 8, wherein the drop bar position sensor is a proximity sensor or a limit switch.

10. The apparatus of claim 9, wherein the controller is configured to interrupt the sensor zeroing process if the drop bar is detected in the pressed position, and the controller is configured to actuate the wheeled transport device.

11. The apparatus of claim 10, wherein the controller is configured to actuate the wheeled transport device when the drop bar is determined to be in a pressed position by actuating a motor, or activating a motor drive loop, or releasing a brake or by releasing a brake and actuating a motor.

12. The apparatus of claim 10, wherein the one or more sensors are force sensors located on the handlebar and configured to detect forces exerted by a user of the wheeled transport device.

13. The apparatus of claim 1, wherein the controller is configured to execute the sensor zeroing process automatically and continuously, while the drop bar is detected as being in the rest position.

14. The apparatus of claim 13, wherein the handlebar and sensor zeroing apparatus are positioned on a wheeled transport device, and wherein the drop bar is pivotably coupled to the handlebar.

15. A wheeled transport device comprising:
a handlebar
a sensor zeroing apparatus comprising
a drop bar moveably coupled to a handlebar of a wheeled transport device, wherein the drop bar is moveable relative to the handlebar between a pressed position and rest position,
a drop bar position sensor located on or adjacent the handlebar,
a controller is operatively coupled to the drop bar position sensor and one or more sensors, wherein the one or more sensors are positioned on the handlebar and/or a wheeled transport device comprising the handlebar,
wherein the controller is configured to a sensor zeroing process if the drop bar is determined to be in the rest position; and,
wherein the wheeled transport device is a trolley or wheelchair.

16. A sensor zeroing method comprising the steps of:
determining if a drop bar is in a pressed position or in a rest position,
measuring sensor values from one or more sensors, if the drop bar is detected as being in a rest position, and;
updating a zero value for each of the one or more sensors while the drop bar is in the rest position.

17. The sensor zeroing method of claim 16, comprising the steps of:
determining if a new sensor value is measured from any one of the one or more sensors,
updating the zero value for each of the one or more sensors if a new sensor value is measured,
storing the updated zero value after each instance the zero value is updated.

18. The sensor zeroing method of claim 17, comprising the steps of:
continuously determining if the drop bar is in a pressed position or a rest position,
continuously executing the steps of:
determining if a drop bar is in a pressed position or in a rest position,
measuring sensor values from one or more sensors, if the drop bar is detected as being in a rest position,
updating a zero value for each of the one or more sensors while the drop bar is in the rest position, and;
determining if a new sensor value is measured from any one of the one or more sensors,
updating the zero value for each of the one or more sensors if a new sensor value is measured,
storing the updated zero value after each instance the zero value is updated,
when the drop bar is in a rest position.

19. The sensor zeroing method of claim 18, comprising the steps of:
receiving signals indicative of a drop bar position from a drop bar position sensor,
determining the position of the drop bar relative to the handlebar,
determining the drop bar is in a pressed position if the distance of the drop bar relative to the handlebar is less than a threshold,
determining the drop bar is in a rest position if the distance between the drop bar and handlebar is greater than the threshold, and
actuating a component of a wheeled transport device comprising the drop bar if the drop bar is detected as being in a pressed position or measuring sensor values and update a zero value and store the updated zero value, if the drop bar is detected as being in a rest position.

20. The sensor zeroing method of claim 19, comprising the steps of:
interrupting the sensor zeroing process if the drop bar is detected in the pressed position and
actuating the wheeled transport device, wherein actuating the wheeled transport device comprises actuating a motor, or activating a motor drive loop, or releasing a brake or by releasing a brake and actuating a motor.
